(19) United States
(12) Patent Application Publication
(10) Pub. No.: US 2025/0237341 A1
(43) Pub. Date: Jul. 24, 2025

(54) APPARATUS, KIT, AND METHOD FOR PIPE CENTRALIZERS

(71) Applicants: Andrew Schellack, Talking Rock, GA (US); Kristofer Laméy, Ellijay, GA (US)

(72) Inventors: Andrew Schellack, Talking Rock, GA (US); Kristofer Laméy, Ellijay, GA (US)

(21) Appl. No.: 19/035,342

(22) Filed: Jan. 23, 2025

Related U.S. Application Data
(60) Provisional application No. 63/623,850, filed on Jan. 23, 2024.

(51) Int. Cl. F16L 55/40; F16L 101/12; F16L 101/30

(52) U.S. Cl. CPC F16L 55/40; F16L 2101/12; F16L 2101/30

(57) ABSTRACT

The subject matter of the present disclosure relates, in various embodiments, to an improved centralizer for use with various pipe tools carried by a guide hose, wherein said improved centralizer can be installed via the side of said guide hose; thus, eliminating the need to remove said pipe tool. Said improved centralizer comprises interchangeable finger set(s) dimensioned to fit around a guide hose, and wherein a first and a second jacket are dimensioned to fit over and secured to said finger set(s). Once fully assembled, said improved centralizer is in the shape of a truncated bi-cone. Said shape facilitates the centering of said pipe tool within the inside of a pipe and allows for continued centering during the movement of said pipe tool through a piping system, including around turns and elbows.

### PRIORITY CLAIM

To the fullest extent permitted under applicable law, the present application claims priority to and benefit of U.S. Provisional Patent Application 63/623,850, filed on Jan. 23, 2024, entitled “Apparatus, Kit, and Method for Pipe Centralizers,” and said provisional patent application is incorporated herein by reference.

### TECHNICAL FIELD

The subject matter of the present disclosure relates, generally, to devices and methods for use with piping. More particularly, the subject matter of the present disclosure relates to an apparatus, kit, and method for use with multiple types of piping tools to assist in centralizing said tool within a pipe during use.

### BACKGROUND

In North America alone, water damage costs insurance companies more than $2.5 billion per year. This number only reflects what insurance companies pay, and does not include the amount paid directly by owners, such as amounts not reimbursed or covered by insurance. As many homeowner insurance policies exclude normal wear and/or neglected maintenance, damage caused by leaking/clogged/burst pipes will sometimes not be covered; thus, resulting in the homeowner being fully, or at least partially, responsible.

In addition to the enormous financial costs associated with leaking or burst pipes, they can also have a huge impact on the environment and the health of the occupants. More specifically, in the U.S. alone, more than 1 trillion gallons of water are lost per year due to leaking pipes, and more than 14,000 people per day are impacted. Because most pipes are behind walls or underground, clogged and/or leaking pipes will often leak for some time before being uncovered. Often, leaking pipes are a result of a partial or fully blocked flow. Not only do clogged pipes cause leaks, they can also cause backflow of hazardous waste product into showers and sinks, and extremely unpleasant odors. Additionally, clogged pipes also cause premature corrosion of piping systems. Whether the leaks are caused by clogged pipes, premature corrosion, material defects, or faulty installation, if these leaks are not discovered for more than only a few days, mold and fungus will began to grow, resulting in potentially severe health problems. For instance, these growing bacteria and microbes can cause E. coli, staph, Legionella, Salmonella, and many other serious health issues. In fact, if left long enough, the home or building may become uninhabitable; thus, resulting in substantial structural damage, along with significant health and environmental concerns.

To minimize and mitigate these risks, it is imperative that the internal portion of piping systems be periodically inspected, repaired, relined, remilled, unclogged, and/or cleaned as needed. To adequately perform these tasks, various tools have been designed for these purposes. More specifically, for inspection purposes, an internal camera or vision system is attached to a hose/tube and guided into and through the piping system; thus, allowing the user to visually see and locate obstructions, defects, misalignments, or other issues. Once located, one of many different types of tools can then be attached to the guide hose/tube for unclogging the obstruction, wherein the tool is guided through the piping system to the area of concern.

One commonly utilized tool is a hydro-jet nozzle which allows high-pressure water to be used to unclog and clean the internal area of the piping system. There are numerous types of hydro-jet nozzles that can be utilized depending on the pipe material/design and the type of clog (i.e., roots, paper, grease, fat, hair, food waste or the like). Another common declogging tool that can be attached to a hose/tube and guided through the piping system is a motorized auger that uses a mechanical rotating head to break-up and release the clogged area. There are other types of milling or grinding tools that, in addition to declogging, can also be used to resurface and/or reline the internal surfaces of a piping system that work in a similar manner, wherein the tool is guided through the piping system.

With all of the above-discussed tools/methods, the biggest challenge to ensure proper operation thereof is to provide an adequate means of centrally guiding the tool through a piping system which likely comprises various turns, angles, and elbows. The tools operate in a radial pattern; therefore, if the tools are not properly centered within the pipe, they will not operate effectively. In addition, while traveling through a piping system, the tools need to be able to travel around bends and curves without getting caught-up and/or damaged. Guiding and centering devices must also reduce the chances that the tool gets snagged, which could cause the guiding hose/tube to bend and the tool (i.e., auger, grinder, hydro-jet, and/or the like) to revert back onto itself; thus, potentially damaging itself and/or the guide hose/tube.

To accomplish this, a device known as a centralizer is utilized. Many different types of centralizers have been designed. However, in light of the present invention, previous prior-art centralizers have many deficiencies. For instance, one such deficiency is in the manner in which they are attached to the guide hose. More specifically, prior-art centralizers are designed to slip onto the end of the hose. This is problematic and labor-intensive because it requires the removal of the tool each time the centralizer is installed, replaced, or removed. Another deficiency with prior-art centralizers is the limitation on size adaptability, wherein different sizes of centralizers are necessary for different-sized guide hoses; thus, requiring the need for the user to maintain a multitude of centralizers. Yet another deficiency found in prior-art attempts is that some centralizers have a partially open design; thus, resulting in debris within the pipes getting caught and trapped within the centralizer. Additionally, many prior-art designs fail to allow the centralizer to adequately maneuver around bends and turns; thus, resulting in an ineffective tool. Ultimately, these deficiencies increase the material costs, labor costs, job completion time, and frustration levels of the users.

Consequently, as can be seen, there is a need for an apparatus, kit, and method for a pipe tool centralizer that (i) can be easily installed from the side; thereby, not requiring removal of the tool head and; thus, reducing labor costs and job duration; (ii) is adaptable for various-sized guide hoses; thus, reducing material costs and tool storage space; and (iii) can easily maneuver through various bends and turns without snagging; thus, increasing the functionality and ease of use. Accordingly, it is to the disclosure of such an apparatus, kit, and method that the following is directed.

### SUMMARY

The subject matter of the present disclosure relates, in various embodiments, to an apparatus, kit, and method that solves the above-discussed deficiencies and problems by providing a new and improved centralizer that can be easily installed from the side, is adaptable for various-sized guide hoses, and can easily maneuver through various bends and turns without snagging.

According to some embodiments, the present invention has a first truncated conically-shaped jacket, a second truncated conically-shaped jacket, a first set of fingers and a second set of fingers; wherein, when assembled, form a truncated bi-cone shape.

A feature and benefit of the present invention is its ability to be installed on a guide hose from the side as opposed to having to remove the tool attached at the end of the guide hose.

Another feature and benefit of the present invention is the ability to use the jackets for multiple-sized guide hoses by simply changing the various-sized finger sets; thus, eliminating the costs associated with having to maintain numerous-sized centralizers.

Another feature and benefit of the present invention is its sharper angled and short bi-conical shape that allows the centralizer to travel throughout a piping system with reduced snagging and ease of maneuverability. Additionally, the bi-conical shape reduces the amount of waste and debris that collects thereon during use; thus, not only reducing snagging, but also reducing the amount of time and effort needed to clean the centralizer after use.

Another feature and benefit of an alternate embodiment of the present invention is the use of a first finger and a second finger as opposed to a first finger set and a second finger set; thus, further facilitating the ease of installation and reduction of parts.

Another feature and benefit of an alternate embodiment of the present invention is the use of a four-star polygon-shaped centralizer that reduces the material costs and reduces movement resistance of the centralizer, as may be found in certain types of clogged piping systems and/or piping systems that are used to transfer thicker types of material (i.e., concrete, oil, food products, or other industrial applications).

Another feature and benefit of an alternate embodiment of the present invention is the use of one or more preferably rubberized, gripping elements disposed within corresponding relief areas within the interior diameter of the centralizer and/or the finger(s), in order to provide additional frictional and/or compression forces to the outside of a guide hose, and, thereby, to provide enhanced clamping of the centralizer to the guide hose.

These, and other features, advantages, and benefits shown by the various embodiments of the present subject matter, and related processes for creating them, as set forth within the present disclosure, will become more apparent to those of ordinary skill in the art after review of the following Detailed Description of Illustrative Embodiments and Claims in light of the accompanying drawing Figures.

### BRIEF DESCRIPTION OF THE DRAWINGS

Accordingly, the within disclosure will be best understood through consideration of, and with reference to, the following drawing Figures, viewed in conjunction with the Detailed Description of Illustrative Embodiments referring thereto, in which like reference numbers throughout the various Figures designate like structure, and in which:

FIG. 1 depicts an exploded perspective view of the preferred embodiment of the present invention, in accordance with the subject matter of the present disclosure;

FIG. 2 depicts an exploded perspective view of the preferred embodiment of the present invention in one use on a guide hose, in accordance with the subject matter of the present disclosure;

FIG. 3 depicts a perspective partially separated view of the preferred embodiment of the present invention in one use on a guide hose, wherein the two finger sets are shown together, and wherein the jackets are shown separated therefrom, in accordance with the subject matter of the present disclosure;

FIG. 4 depicts a fully assembled perspective view of a preferred embodiment of the present invention, in accordance with the subject matter of the present disclosure;

FIG. 5 depicts an exploded perspective view of an alternate embodiment of the present invention, wherein a single first and a single second finger is shown, in accordance with the subject matter of the present disclosure;

FIG. 6 depicts an exploded perspective view of an alternate embodiment of the present invention, in accordance with the subject matter of the present disclosure;

FIG. 7 depicts a fully assembled perspective view of an alternate embodiment of the present invention, in accordance with the subject matter of the present disclosure; and

FIG. 8 depicts various side, exploded, and perspective views of an alternate embodiment of the present invention, depicting one or more preferably rubberized, gripping elements and corresponding centralizer and/or finger reliefs, in accordance with the subject matter of the present disclosure.

It is to be noted that the drawing Figures presented are intended solely for the purpose of illustration and that they are, therefore, neither desired nor intended to limit the inventive subject matter to any or all of the exact details of construction shown, except insofar as they may be deemed essential to the claimed invention.

### DETAILED DESCRIPTION OF ILLUSTRATIVE EMBODIMENTS

In describing the several embodiments illustrated in the Figures, specific terminology is employed for the sake of clarity. The inventive subject matter, however, is not intended to be limited to the specific terminology so selected, and it is to be understood that each specific element includes all technical equivalents that operate in a similar manner to accomplish a similar purpose. Additionally, in the Figures, like reference numerals and like description shall be used to designate corresponding elements, parts, and functionality throughout the several Figures.

To better understand how the present invention interacts with various types of piping tools, a short description of a few different variations will be discussed. Generally speaking, for use within the internal area of a piping system, there are three main categories of piping tools: inspection, cleaning/clearing, and repair/restoration. The purpose of these tools is to provide a means by which one can inspect, clear, repair, and/or refurbish a piping system, without the need to perform extensive digging to get access to underground piping or to destructively open up walls or floors. Without these types of tools, performing the above tasks would be extremely expensive, time-consuming, labor intensive, and, in many situations, cost prohibitive.

Depending upon the task to be performed, a head tool (not shown) is attached to the end of a guide hose A, wherein the head tool and guide hose A are extended into a piping system. More specifically, if the task to be performed is an inspection, the head tool is one of many types of vision systems, such as a camera. If the task to be performed is for clearing purposes, the head tool could be a hydro-jet nozzle, auger, milling device, or similar tool. If the task is to refurbish/reline the pipe or to repair misalignments or defects, the milling head may be utilized.

For and within the context of the present disclosure, it will be recognized by one of ordinary skill in the art that one form of structure and use of a “guide hose” element may be as described above: attaching a head tool to a high-pressure jetting hose, hydro-jet nozzle, or the like. It will be further recognized, however, that, In addition to jetting hoses of various outside diameters, additional applications of the subject matter of the present disclosure can include use in association with milling cables and/or camera heads that utilize pushrods, or pushrod-type mechanical elements. Accordingly, for and within the context of the present disclosure, the term “guide hose,” and/or variants thereof, shall be construed in scope, nature, and breadth to include all such elements, structures, and uses.

Additionally, there are other applications within other industries such as cement, oil, HVAC, chimney, and the like, wherein similar methods of using a guide hose A, rebar, pipe, or rod are utilized to guide a tool through an internal chamber. Consequently, the present device, including the alternate embodiments thereof, could be used to improve many of these applications.

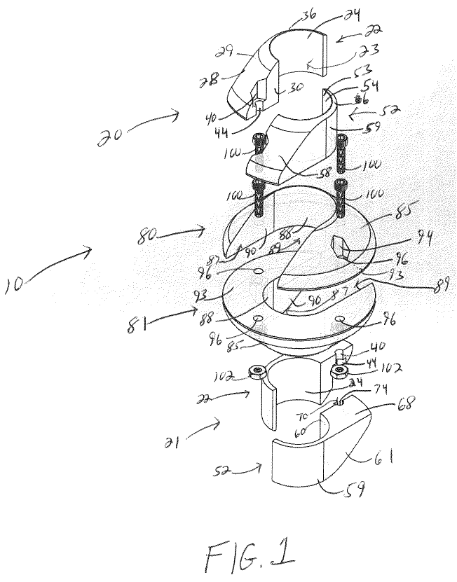

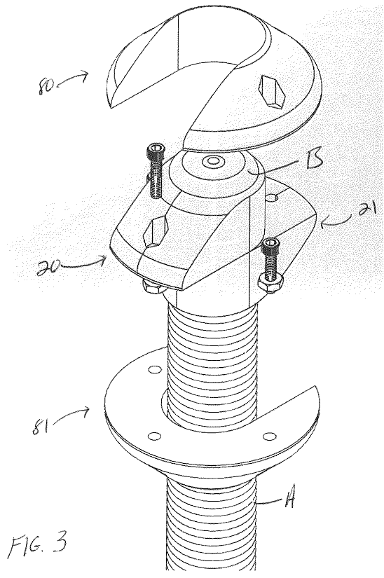

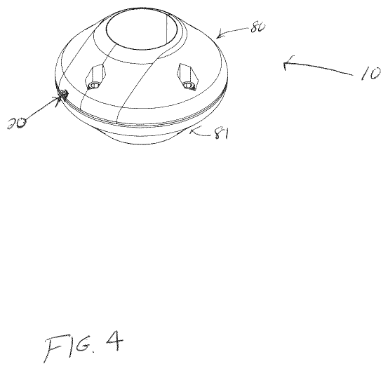

Turning now to the drawing Figures generally, and specifically to FIGS. 1-4, an exploded perspective view of a preferred embodiment of present invention 10 is depicted, wherein said preferred embodiment 10 comprises finger set 20, second finger set 21, first jacket 80, second jacket 81, bolt set 100, and nut set 102. First finger set 20 and second finger set 21 are identical, and first jacket 80 is identical to second jacket 81. Additionally, bolt set 100, in this preferred embodiment, comprises 4 identical bolts 100, and nut set 102 comprises 4 identical nuts 102, each dimensioned to receive and secure each of said bolts.

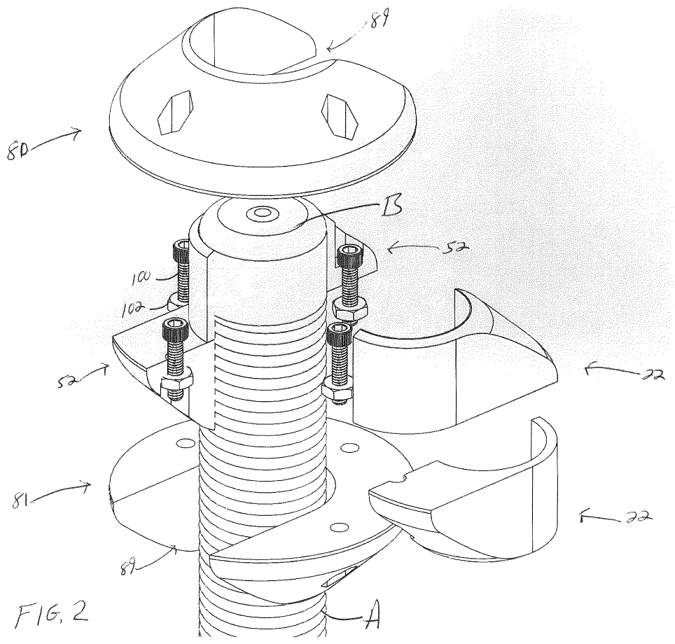

With continuing reference to FIG. 1, and with further reference to FIGS. 2-4, first finger set 20 and second finger set 21 each comprises two fingers. For clarity purposes, in describing each of the four fingers herein, said fingers will be referenced as first finger 22 and second finger 52, wherein each finger set 20 and 21 comprises one each of first finger 22 and second finger 52. As shown in the referenced figures, second finger set 21 is identical to first finger set 20 however, in use, second finger set 21 is rotated 180° about the axis perpendicular to the guide hose A. Now referring more specifically to each finger, first finger 22 generally comprises an interior surface 23, an exterior surface 29, a top surface 36, a bottom surface 38, a semi-circular portion 24 and an elongated portion 31. The interior surface 23 of semi-circular portion 24 is semi-circular in shape and dimensioned to radially receive approximately half of the guide hose A therein. As various-sized guide hoses A are utilized, depending on the task to be performed, the dimensions of semi-circular portion 24 can be varied for different fingers to accommodate accordingly. As discussed further below, this feature allows first jacket 80 and second jacket 81 to be utilized for a multitude of sized guide hoses A, wherein finger sets 20, 21, having varying sizes, can be changed to accommodate the appropriately sized guide hose A. The exterior surface 29 of semi-circular portion 24 is also semi-circular in shape, wherein semi-circular portion 24 extends a length to form a semi-cylindrical shape. The bottom surface 38 of semi-circular portion 24 is generally flat. Extending from semi-circular portion 24 is elongated portion 31, wherein the bottom surface 38 thereof generally comprises a flat rectangular profile, wherein exterior surface 29 thereof generally comprises a truncated cone shape 28, and wherein interior surface 23 thereof generally comprises a flat triangular profile 30. For securing purposes, a through-hole 44 is formed through elongated portion 31, along with recessed area 40. As described more fully below, through-hole 44 is dimensioned to receive bolt 100 therethrough, and wherein recessed area 40 is dimensioned to receive the head of bolt 100 or nut 102, as applicable.

Second finger 52 is a mirror image of first finger 22, wherein second finger 52 generally comprises an interior surface 53, an exterior surface 59, a top surface 66, a bottom surface 68, a semi-circular portion 54, and an elongated portion 61. The interior surface 53 of semi-circular portion 54 is semi-circular in shape and dimensioned to radially receive approximately half of the guide hose A therein. As various-sized guide hoses A are utilized depending on the task to be performed, the dimensions of semi-circular portion 54 can be varied for different fingers to accommodate accordingly. As discussed further below, this feature allows first jacket 80 and second jacket 81 to be utilized for a multitude of sized guide hoses A, wherein finger sets 20, 21, having varying sizes, can be changed to accommodate the appropriately-sized guide hose A. The exterior surface 59 of semi-circular portion 54 is also semi-circular in shape, wherein semi-circular portion 54 extends a length to form a semi-cylindrical shape. The bottom surface 68 of semi-circular portion 54 is generally flat. Extending from semi-circular portion 54 is elongated portion 61, wherein the bottom surface 68 thereof generally comprises a flat rectangular profile, wherein exterior surface 59 thereof generally comprises a truncated cone shape 58, and wherein interior surface 53 thereof generally comprises a flat triangular profile 60. For securing purposes, a through-hole 74 is formed through elongated portion 61 along with recessed area 70. As described more fully below, through-hole 74 is dimensioned to receive bolt 100 therethrough, and wherein recessed area 70 is dimensioned to receive the head of bolt 100 or nut 102, as applicable. In use, first finger 22 is mated with second finger 52, wherein semi-circular portion 24 and semi-circular portion 54 encircle guide hose A, and wherein flat triangular profile 30 of first finger 22 mates with flat triangular profile 60 of second finger 52. When mated together, first finger 22 and second finger 52 generally form a cylindrical portion having a triangular prism portion extending therefrom.

As stated above, first jacket 80 and second jacket 81 are identical. In use, however, second jacket 81 is rotated 180° about an axis perpendicular to guide hose A. First jacket 80 and second jacket 81 generally comprises an interior surface 87, an exterior surface 85, and a flat side 93. The exterior surface 85 of jackets 80, 81 is generally in the shape of a truncated cone. A cutout section 89 is formed in jackets 80, 81, wherein cutout section 89 is dimensioned to receive therein first finger set 20 and second finger set 21, respectively. More specifically, cutout section 89, comprises cylindrical portion 88 and a prism portion 90, wherein cylindrical portion 88 is dimensioned to receive the cylindrical shape formed when first finger 22 and second finger 52 are placed together. Prism portion 90 is dimensioned to receive the prism shape formed when first finger 22 and second finger 52 are placed together. Jackets 80, 81 further comprise three through-holes 96 formed therethrough and three recessed areas 94, wherein through-holes 96 are dimensioned to receive bolts 100 therethrough, and wherein recessed areas 94 are dimensioned to receive the head of bolt 100 or nut 102. Although jackets 80, 81 and finger sets 20, 21 of the preferred embodiment, together utilizes four points of connection, it is contemplated in alternate embodiments that fewer or more points of connection may be incorporated.

For a point of reference and for describing how the present invention 10 is installed, the tool attachment end B of guide hose A will be referred to as the upstream direction and the opposing end of the guide hose A will be referred to as the downstream direction. It will be noted that these directional references may or may not coincide with the normal directional flow within the piping system at issue and is, thus, only utilized herein to clarify how the present invention 10 is installed onto a guide hose A.

To install the present invention 10 onto a guide hose A, as shown in FIG. 1 and FIG. 2, starting from the side of guide hose A, first finger 22 and second finger 52 are first positioned around the guide hose A downstream of the tool attachment end B, wherein first finger's 22 interior surface 23 of semi-circular portion 24 and second finger's 52 interior surface 53 of semi-circular portion 54 encircle guide hose A, and wherein first finger's 22 interior surface 23 of elongated portion 31 mates with second finger's 52 interior surface 53 of elongated portion 61. Next, continuing reference to FIG. 1 and FIG. 2, another first finger 22 and second finger 52 (together comprising second finger set 21) are rotated 180° about an axis perpendicular to guide hose A, and then, from the side of guide hose A, first finger 22 of second finger set 21 and second finger 52 of second finger set 21 are first positioned around the guide hose A downstream and adjacent to first finger set, wherein first finger's 22 interior surface 23 of semi-circular portion 24 and second finger's 52 interior surface 53 of semi-circular portion 54 encircle guide hose A, and wherein first finger's 22 interior surface 23 of elongated portion 31 mates with second finger's 52 interior surface 53 of elongated portion 61. Second finger set 21 and first finger set 20 are positioned together such that flat surfaces 38 and 58 of each finger set 20, 21 are in direct contact. Next, first jacket 80 is slid onto and over first finger set 20, and then second jacket 81 is rotated 180° about an axis perpendicular to the guide hose A, and then slid onto and over second finger set 21, wherein flat surfaces 93 of each jacket 80, 81 are in contact, and wherein two through-holes 96 of first jacket 80 align with two through-holes 96 of second jacket 81, and wherein one through-hole 96 of first jacket 80 aligns with through-holes 44 and through-hole 74 of first finger set 20, and wherein one through-hole 96 of second jacket 81 align with through-hole 44 and through-hole 74 of second finger set 21. With nuts 102 positioned on the downstream side of the present invention 10 within each of the recessed areas, bolts 100 are extended through each of the through-holes from the upstream side and tightly secured via nuts 102. Although the use of bolts 100 and nuts 102 are described in the preferred embodiment, it is also contemplated, in alternate embodiments, that a snap-fit type connection such as cantilever, torsion, or annular is utilized, wherein nuts, bolts, through-holes, and recessed areas would not be necessary. It is also contemplated, in alternate embodiments, that frictionally fitting through-hole plugs (not shown) could be used to further reduce any drag caused by debris collecting inside the recessed areas and further reduce cleaning efforts after use.

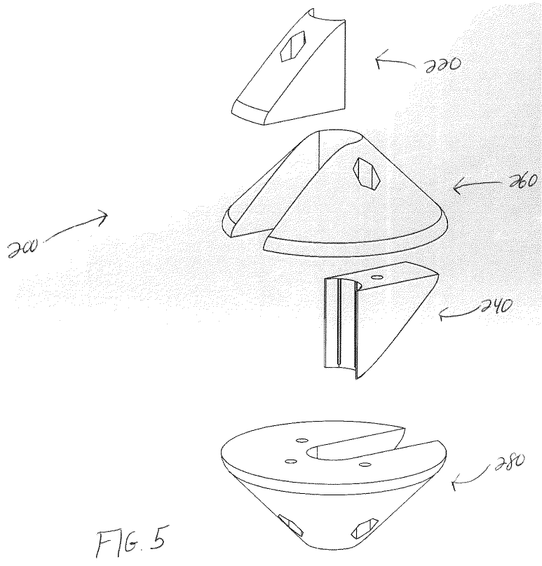

Now referring to FIG. 5, first alternate embodiment 200 is shown, wherein first alternate embodiment 200 comprises first finger 220, second finger 240, first jacket 260, and second jacket 280. First alternate embodiment 200, is installed and functions similarly as preferred embodiment 10, except to the extent that first finger 220 is formed as one single piece as opposed to a set of two fingers, and second finger 240 is formed as one single piece as opposed to a set of two fingers.

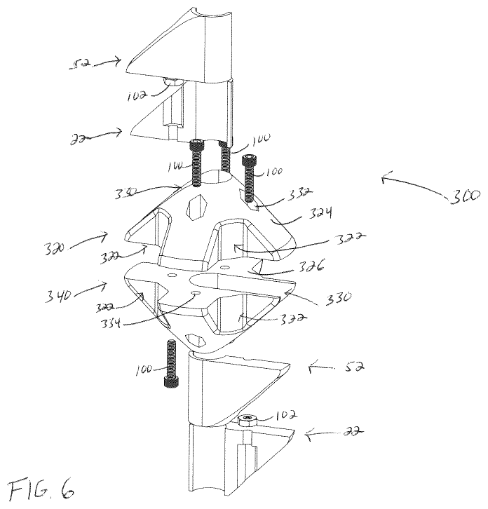

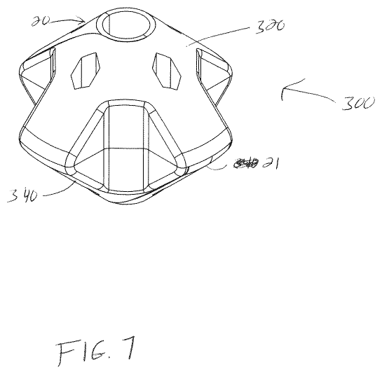

Now referring to FIG. 6 and FIG. 7, a second alternate embodiment 300 is shown, wherein second alternate embodiment 300 is generally a bi-cone shape having a star polygon profile. Second alternate embodiment 300 utilizes the same fingers 22, 52 as in the preferred embodiment 10, as described fully above. However, second alternate embodiment 300 differs from the preferred embodiment 10 in that second alternate embodiment 300 has a first jacket 320 and a second jacket 340, wherein first jacket 320 is identical to second jacket 340 except that, in use, second jacket 340 is rotated about an axis that is perpendicular to the axis of the guide hose A. First jacket 320 and second jacket 340, each have a first side 324 and a second side 326, wherein first side 324 forms generally a truncated cone shape, and wherein second side 326 is generally flat. First jacket 320 and second jacket 340 each have four equally spaced-apart generally U-shaped cut out sections 322; thus, resulting in each jacket 320, 340 having a generally star polygon profile. Similar to preferred embodiment 10, second alternate embodiment 300 further comprises a cutout area 330 dimensioned to receive fingers 22, 52. In use, second alternate embodiment 300 is installed in the same manner as preferred embodiment as described above.

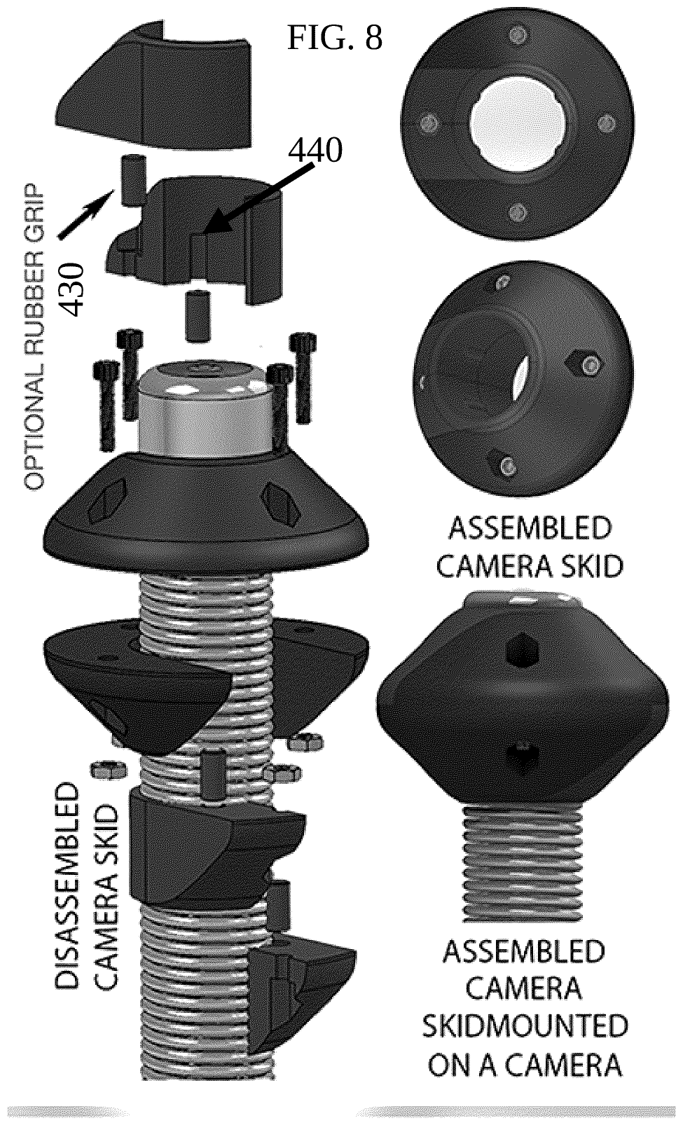

Referring now to FIG. 8, a further alternate embodiment of the present invention is depicted. In this embodiment, one or more preferably rubberized gripping element(s) 430 are disposed within corresponding relief areas 440 within the interior diameter of the centralizer and/or the finger(s), in order to provide additional frictional and/or compression forces to the outside of a guide hose, and, thereby, to provide enhanced clamping of the centralizer to the guide hose.

For reference purposes only and not to limit the present invention dimensionally, the fully assembled preferred embodiment 10 and fully assembled alternate embodiments 200, 300 have, preferably, an exterior wall angle of 35-65 degrees and an overall assembled length, preferably of approximately 3-6 inches. It should be noted that for various applications, one skilled in the art, with the benefit of this present disclosure, could choose angles and lengths outside of these preferred measurements. More specifically, based on the known sizes of guide hose A and the piping system to be inspected/cleaned/refurbished coupled with the present disclosure, one skilled in the art would be able to dimension the present invention appropriately for the needed application.

Also provided herein is a kit, wherein said kit comprises a plurality of parts, as described variously in the embodiments above, that allows the user to easily adjust the fingers and/or other components so as to fit a multitude of guide hoses. More specifically, guide hoses typically come in sizes ranging from ¼″ to 1½″ ID. Thus, said kit would comprise separate size finger sets and/or other components to allow the present invention to fit on these most common sizes.

For convenience of the reader, following is a summary of parts and reference numbers in the written Specification and Drawings hereof:

### PART NUMBER PART DESCRIPTION

A Guide Hose
B Tool Attachment End
10 Preferred Embodiment
20 First Finger Set
21 Second Finger Set
22 First Finger
23 Interior Surface
24 Semi-Circular Portion
28 Truncated Cone
29 Exterior Surface
30 Triangular Profile
31 Elongated Portion
36 Top Surface
38 Bottom Surface
40 Recessed Area
44 Though-hole
52 Second Finger
53 Interior Surface
54 Semi-Circular Portion
58 Truncated Cone
59 Exterior Surface
60 Triangular Profile
61 Elongated Portion
66 Top Surface
68 Bottom Surface
70 Recessed Area
74 Through-hole
80 First Jacket
81 Second Jacket
85 Exterior Surface
87 Interior Surface
88 Cylindrical Portion
89 Cutout Section
90 Prism Portion
93 Flat Surface
94 Recessed Area
96 Through-hole
100 Bolt
102 Nut
200 First Alternate Embodiment
220 First Finger
240 Second Finger
260 First Jacket
280 Second Jacket
300 Second Alternate Embodiment
320 First Jacket
322 U-Shaped Cutout Sections
324 First Side
326 Second Side
330 Cutout Area
340 Second Jacket
430 Gripping Element
440 Gripping Element Relief

Having, thus, described exemplary embodiments of the subject matter of the present disclosure, it is noted that the within disclosures are exemplary only, and that various other alternatives, adaptations, and modifications may be made within the scope and spirit of the present inventive subject matter. Accordingly, the present subject matter is not limited to the specific embodiments as illustrated herein, but is limited only by the following claims.

What is claimed:

1. A centralizer apparatus for use with a guide member, comprising:
a first finger, wherein said first finger is dimensioned to fit at least partially around and carried by the guide member;
a second finger, wherein said second finger is dimensioned to fit at least partially around and carried by the guide member;
a first jacket, wherein said first jacket is dimensioned to receive said first finger; and
a second jacket, wherein said second jacket is dimensioned to receive said second finger.

2. The centralizer apparatus of claim 1, wherein each finger comprises an interior surface, an exterior surface, a top surface, a bottom surface, a semi-circular portion, and an elongated portion.

3. The centralizer apparatus of claim 2, wherein the exterior surface comprises a truncated cone shape.

4. The centralizer apparatus of claim 2, wherein the interior surface of each semi-circular portion is configured to receive therein at least a portion of the guide member.

5. The centralizer apparatus of claim 2, wherein each jacket is configured to accept at least one of a plurality of alternative fingers, such at least one alternative finger comprising an interior surface of each semi-circular portion configured to receive therein at least a portion of a corresponding-sized guide member.

6. The centralizer apparatus of claim 1, wherein the assembled centralizer apparatus comprises a bi-cone shape, the bi-cone shape further comprising a first truncated cone shape and a second truncated cone shape, cojoined at their bases, such that each truncated apex is oriented at approximately 180 degrees with respect to the other.

7. The centralizer apparatus of claim 1, wherein the assembled centralizer apparatus comprises a truncated bi-cone shape, the truncated bi-cone shape further comprising a first star polygon shape and a second star polygon shape, cojoined at their bases, such that each truncated apex is oriented at approximately 180 degrees with respect to the other.

8. The centralizer apparatus of claim 1, wherein first and second jackets are cojoined via a fastener.

9. The centralizer apparatus of claim 1, wherein a plurality of gripping elements may be disposed within cooperating relief areas disposed within an interior diameter of the centralizer apparatus and/or a finger thereof.

10. A centralizer apparatus for use with a guide member, comprising:
a first finger, wherein said first finger is dimensioned to fit at least partially around and carried by the guide member;
a second finger, wherein said second finger is dimensioned to fit at least partially around and carried by the guide member;
a third finger, wherein said third finger is dimensioned to fit at least partially around and carried by the guide member;
a fourth finger, wherein said fourth finger is dimensioned to fit at least partially around and carried by the guide member;
a first jacket, wherein said first jacket is dimensioned to receive said first finger and said second finger; and
a second jacket, wherein said second jacket is dimensioned to receive said third finger and said fourth finger.

11. The centralizer apparatus of claim 10, wherein each finger comprises an interior surface, an exterior surface, a top surface, a bottom surface, a semi-circular portion, and an elongated portion.

12. The centralizer apparatus of claim 11, wherein the exterior surface comprises a truncated cone shape.

13. The centralizer apparatus of claim 11, wherein the interior surface of each semi-circular portion is configured to receive therein at least a portion of the guide member.

14. The centralizer apparatus of claim 11, wherein each jacket is configured to accept at least one of a plurality of alternative fingers, such at least one alternative finger comprising an interior surface of each semi-circular portion configured to receive therein at least a portion of a corresponding-sized guide member.

15. The centralizer apparatus of claim 10, wherein the assembled centralizer apparatus comprises a bi-cone shape, the bi-cone shape further comprising a first truncated cone shape and a second truncated cone shape, cojoined at their bases, such that each truncated apex is oriented at approximately 180 degrees with respect to the other.

16. The centralizer apparatus of claim 10, wherein the assembled centralizer apparatus comprises a truncated bi-cone shape, the truncated bi-cone shape further comprising a first star polygon shape and a second star polygon shape, cojoined at their bases, such that each truncated apex is oriented at approximately 180 degrees with respect to the other.

17. The centralizer apparatus of claim 10, wherein first and second jackets are cojoined via a fastener.

18. The centralizer apparatus of claim 10, wherein a plurality of gripping elements may be disposed within cooperating relief areas disposed within an interior diameter of the centralizer apparatus and/or a finger thereof.

19. A method of centering an internal piping tool carried by a guide member, said method utilizing a centralizer having a first finger, wherein said first finger is dimensioned to fit at least partially around and carried by the guide member; a second finger, wherein said second finger is dimensioned to fit at least partially around and carried by the guide member; a third finger, wherein said third finger is dimensioned to fit at least partially around and carried by the guide member; a fourth finger, wherein said fourth finger is dimensioned to fit at least partially around and carried by the guide member; a first jacket, wherein said first jacket is dimensioned to receive said first finger and said second finger; and a second jacket, wherein said second jacket is dimensioned to receive said third finger and said fourth finger; the method comprising the steps of:
(a.) positioning said first finger and said second finger around the guide member from the side of the guide member;
(b.) positioning said third finger and said fourth finger around the guide member from the side of the guide member and proximal to said first finger and said second finger;
(c.) positioning and securing said first jacket over and around said first and said second fingers from the side of the guide member; and
(d.) positioning and securing said second jacket over and around said third and said fourth fingers from the side of the guide member.

20. The method of claim 19, further comprising step (e.) wherein first and second jackets are cojoined via a fastener.
